(19) United States
(12) Patent Application Publication
(10) Pub. No.: US 2015/0202583 A1
(43) Pub. Date: Jul. 23, 2015

(54) APPARATUS TO REDUCE CATALYST FLUIDIZATION IN REGENERATION UNITS

(71) Applicant: UOP LLC, Des Plaines, IL (US)

(72) Inventors: Ka L. Lok, Buffalo Grove, IL (US); Mary Jo Wier, Schaumburg, IL (US); Pengfei Chen, Glenview, IL (US); Alexander V. Sabitov, Wilmette, IL (US)

(21) Appl. No.: 14/673,050

(22) Filed: Mar. 30, 2015

Related U.S. Application Data
(63) Continuation-in-part of application No. 13/490,085, filed on Jun. 6, 2012.
(60) Provisional application No. 61/502,944, filed on Jun. 30, 2011.

(51) Int. Cl. B01J 8/12

(52) U.S. Cl. CPC B01J 8/125; B01J 2208/00938

(57) ABSTRACT

The invention reduces the potential for catalyst fluidization in a reduction vessel of a continuous catalyst regeneration system. The gas exit area from the catalyst reduction zone is increased by ventilating the cylindrical baffle of the upper reduction zone. This provides an increased exit cross-sectional area for the upper reduction gas to escape and reduce the overall exit velocity of the combined upper and lower reduction gases and reduces the potential for catalyst fluidization.

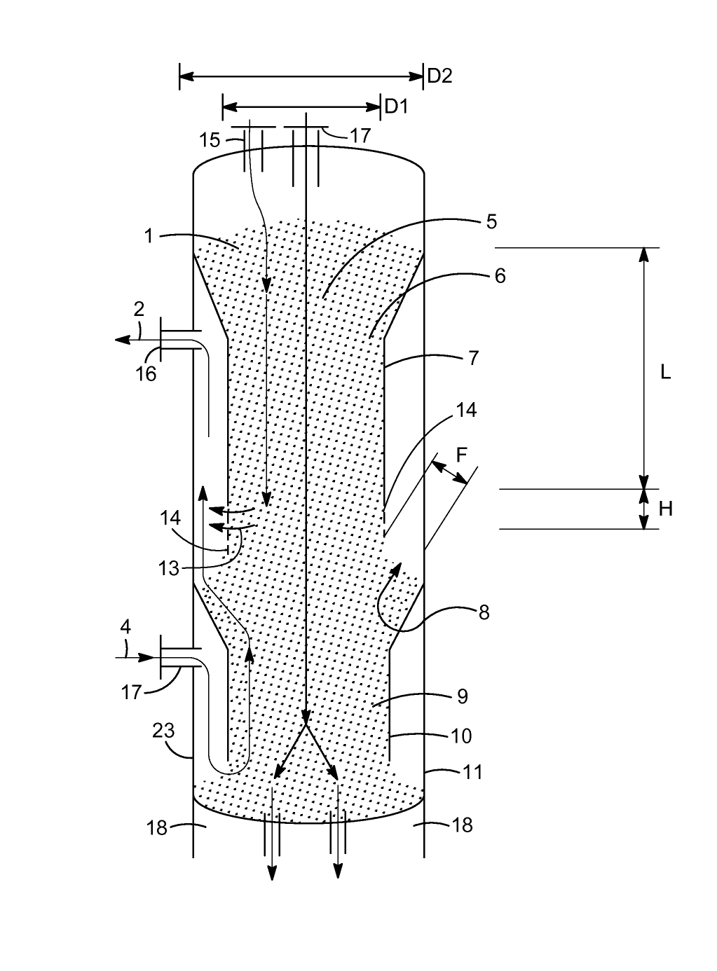

### CROSS-REFERENCE TO RELATED APPLICATIONS

This application is a Continuation-In-Part of copending Application No. 13/490,085 filed Jun. 6, 2012, which application claims priority from Provisional Application No. 61/502,944 filed Jun. 30, 2011, now expired, the contents of which are hereby incorporated by reference.

### BACKGROUND OF THE INVENTION

This invention relates to an apparatus and process to reduce catalyst fluidization in catalyst regeneration units. More particularly, this invention relates to the use of ventilated annular baffles to lower the gas velocity of gases exiting continuing catalyst regeneration units (CCR).

Although catalysts for the conversion of hydrocarbons have a tendency to deactivate, usually a catalyst's activity may be restored by one of a number of processes that are known generally as regeneration processes. Regeneration processes are extensively used. The specific steps that comprise a regeneration process depend in part on the reason for the deactivation. For example, if the catalyst contains a catalytic metal such as platinum, regeneration usually includes oxidizing the metal by contacting the catalyst with oxygen. In an oxidized state, however, the catalyst metal is generally not in its most active form for promoting hydrocarbon conversion reactions. Consequently, regeneration often also includes reducing the oxidized metal by contacting the catalyst with hydrogen. Water is formed as a byproduct during the reduction reaction of the metals. Sufficient hydrogen flow rate is required to sweep the water from the catalyst during the reduction reaction to achieve its optimal activity conditions. Operating conditions and methods for such catalyst reduction steps are well known. Regeneration processes that include a catalyst reduction step can be carried out in situ, or the catalyst may be withdrawn from the vessel in which the hydrocarbon conversion takes place and transported to a separate regeneration zone for reactivation. Arrangements for continuously or semi continuously withdrawing catalyst particles from a reaction zone and for reactivation in a regeneration zone are well known. In one type of regeneration system, there are both upper and lower reduction zones where the upper reduction gases and lower reduction gases combine to exit the catalyst bed between an upper cylindrical baffle and the shell of the reduction zone vessel. It has been found that the gas velocity of the combined reduction gas flow can be too high which can result in catalyst attrition and catalyst carry-over clogging of vent gas lines.

### SUMMARY OF THE INVENTION

It has been found that modification of the bottom portion of the annular baffle that defines the upper reduction zone can provide a solution to the above described problems. More specifically, the addition of about a 1 inch (25.4 mm) to 24 inch (611 mm), preferably a 10 inch (254mm) ventilated screen or a perforated plate to the bottom of the annular baffle sufficiently solves the problem of excessive gas velocity of the combined reduction gas flow and excessive attrition.

The reduction vessel of the present invention has a reduction zone comprising an upper reduction zone and a lower reduction zone wherein the upper reduction zone comprises an annular shaped baffle and an annular shaped opening and wherein a portion of said annular shaped baffle adjacent to the opening is a ventilated section. The portion of the annular shaped baffle may comprise a screen.

In another embodiment, the invention involves a device for discharging a catalyst containing stream from a continuing catalyst regeneration unit comprising an annular shaped baffle having an upper portion to retain catalyst particles and a lower portion having openings. The lower portion typically comprises a perforated plate or a screen. In a typical embodiment, from 10 to 40% of the lower portion comprises the perforated plate or screen.

In yet another embodiment, the invention involves an apparatus to increase a flow of gas exiting a reduction vessel comprising a cylindrical shaped vessel wherein within the cylindrical shaped vessel is positioned at least one annular baffle wherein a portion of a surface of the annular baffle comprises a screen. In this apparatus, about 70 to 100 percent of the upper reduction flow of gas exits the reaction vessel through the screen. The screen may be above an opening through which a majority of said gas passes. The process of the invention involves the regeneration of a catalyst in which the catalyst is heated catalyst within a cylindrically shaped reduction vessel having an annular shaped baffle in an upper portion of said reduction vessel and an opening below to the annular shaped baffle for discharge of a regenerated catalyst stream and openings.

### BRIEF DESCRIPTION OF THE DRAWING

The FIGURE shows a reduction vessel with an upper annular baffle and a ventilation device such as a screen together with a lower annular baffle.

### DETAILED DESCRIPTION OF THE INVENTION

The invention involves the use of a vessel for use in reduction of oxidized catalyst to produce a reduced catalyst. This vessel is generally cylindrical or/and conical; preferably a combination of both; in shape, containing annular baffles which have a nominal length-to-diameter ratio in the range from about 0.5 to 10 and preferably from 0.5 to 5. In its upright operating position, the vessel has an upper end and a lower end with an upper reduction zone within the upper end and a lower reduction zone within the lower end. The inside of the vessel is defined as an annular shape that varies in diameter. Oxidized catalyst is introduced into the upper end of the reduction vessel. A reducing gas that is rich in hydrogen is introduced into both the upper and the lower reduction zones. This reducing gas is heated to operating temperatures prior to being introduced. A significant amount and, preferably greater than 80% of the reducing gas is removed from the reduction vessel through a reduction vent gas line locating at the vertical part of the vessel. It has been found that this reduction vent gas line may be clogged up by catalyst particles due to catalyst particle fluidization as result of excessive gas exit velocity at the catalyst free surface area which locates between the bottom of the upper reduction Baffle and top of the lower reduction baffle. Such particles are produced through attrition of catalyst. In particular, attrition can be the result of due to catalyst fluidization in the reduction zone. An excessive gas exit velocity has been found to result in an increase in catalyst attrition.

In the present invention, it has been found advantageous to ventilate the bottom section of the annular baffle of the upper reduction zone by replacing a section of solid baffle with a material having openings, such as a profile wire screen or a perforated plate. This ventilated area allows the upper reduction gas to escape and reduces the exit velocity of the combined upper and lower reduction gases from the catalyst bed and thereby reduce the potential for fluidizing the catalyst.

The FIGURE shows an illustrative embodiment of the present invention. A reduction vessel 11 is shown with the reduction zones, baffles, gas streams and catalyst streams as follows. An upper reduction gas stream 1 is seen entering upper reduction gas inlet nozzle 15 locating above the upper reduction zone baffle and it flows concurrently and axially in the non-ventilated section of the upper annular baffle 7 in the upper catalyst bed 9, then it flow radially outward passing through a ventilation device 14, such as a screen, as upper reduction gas stream 13 flows across ventilated device 14. An upper annular baffle 7 is shown positioned in an inward position from an outer wall 23 of reduction vessel 11. A lower reduction gas stream 4 is shown entering reduction vessel 11 through lower reduction gas inlet nozzle 17 located in the vertical part of the vessel 11. Lower reduction gas stream 4 is shown travelling axially in an upper direction to proceed to catalyst free surface area 8 locating between the outer wall 23 and the ventilated section of upper annular baffle 7 and then combines with upper reduction gas stream 1 to form combined reduction gas stream 2 that is shown exiting reduction vessel 11 through combined reduction gas outlet nozzle 16. A catalyst down flow stream 5 enters reduction vessel 11 through catalyst inlet nozzle 17, passing through upper reduction zone 6, lower reduction zone 9 and then exiting through catalyst outlet nozzles 18 at the bottom of reduction vessel 11. On the right side of the

FIGURE is seen upper annular baffle 7 having a length L and ventilation device 14, such as a screen having a length H are shown on the right side of the FIGURE. Length L is significantly greater than length H as shown in the FIGURE. Adjacent to ventilation device 14 is located a catalyst free surface area 8 having a width F. Also shown in the FIGURE are lower annular baffle 10. At the top of the FIGURE are shown distances D1 and D2. D2 is the horizontal diameter of reduction vessel 11 and D1 is the diameter of the area defined by the upper annular baffle 7 and lower annular baffle 10.

The apparatus of the present invention includes a ventilation device 14 below the non-perforated annular baffle 7 to structurally provide a passageway for upper reduction gas stream 1 firstly flow downward co-currently with the catalyst flow in the non-perforated annular baffle 7 section, and then the perforated section of the annular baffle to provide a passageway to allow the gas to flow radically outward across within a single catalyst particle bed. This configuration structurally and hydraulically diverts upper reduction gas 1 away catalyst free surface area 8 and therefore it structurally separates upper reduction zone gas 1 from lower reduction gas stream 4 at catalyst free surface area 8. The catalyst particle bed is defined by a single retention device with a compact configuration due to the baffles. The upper retention device is essentially made of a non-perforated cylinder—the upper annular baffle 7 where the gas and catalyst particles contact in a downflow movement of the catalyst. A small portion of the upper retention device (10-40% of vertical length is perforated where the gas is separated from the catalyst particles and outflows from the center line of the overall vessel to the outer wall of the vessel. The single retention device creates a catalyst compacted in the center from top to bottom in both the non-perforated upper annular baffle 7 and the ventilated device 14. The catalyst inlet nozzle 17 is shown on the top of the vessel, but may be located on any part of the top of the vessel, including on the center line as shown in the FIGURE.

The catalyst retention device formed by upper annular baffle 7 is attached to the side of the vessel wall to provide gravity support for the structure and it does not comprise an additional guide for the purpose of centering. The angled portion of this baffle partitions the catalyst particles from combined reduction gas stream 2.

Ventilated upper annular baffle (including the ventilation device) (7 and 14) and lower annular baffle provide a passageway allowing the Upper Reduction Gas and Lower Reduction Gas to combined at the mid-section of the vessel and exit the vessel through a single gas outlet nozzle.

A benefit of the present invention is to provide between a 30.7 and 152% increase in surface area for gas to escape based on the height of the ventilated screen 10 inch (254 mm) for regeneration size of circulating between 318 to 3045 kg of catalyst per hour and, depending upon the dimensions of the ventilated screen chosen, both in the total surface area of the ventilated screen and the ratio of openings to screen material. This increase can be about 152% in surface area for a small catalyst regeneration unit (750 lb/hr, 340 kg/hr) and about 30.7% for a large regeneration unit (4500 lb/hr, 2041 kg/hr) based on height of ventilated screen of 10 inches (254 mm). For existing operating reduction vessel, since the present invention does not change the overall length of the upper baffle which does not need to change from the original design. There is no change to the catalyst flow regime for good even catalyst flow. However, while there is some loss in heat transfer efficiency between the hot upper reduction gas and the cold catalyst, this transfer is expected to be small and can be easily compensated for by adjustments in heating the reduction gases. For existing operating vessels there also is no need for modifications to the design of the reduction zone shell or addition of any extension to the reduction zone. These features make it feasible to revamp a catalyst reduction unit to resolve issues involving frequent catalyst fluidization. The following comparison table illustrates the increase in percentage of cross-sectional area for various regeneration unit sizes ranging from 340 kg/hr (750 lb/hr) to 2041 kg/hr (4500 lb/hr). A further advantage of the use of the screen material is that this is a low cost solution to a significant problem.

TABLE

| | | | | | | |
|---|---|---|---|---|---|---|
| | | A | Regenerator size-Catalyst Circulation | 318 | 682 | 2045 |
| | | | Rate, kg/hr | | | |
| Case | Unventilated | B | Reduction Vessel inside diameter | 0.975 | 1.325 | 2 |
| A | Configuration | | (D2), meter | | | |
| | | C | Upper Baffle diameter (D1), meter | 0.7 | 0.875 | 0.95 |
| | | D | Available Vapor Escape Cross section | 0.36 | 0.78 | 2.43 |
| | | | area (Catalyst Free Surface 8), sq m | | | |
| Case | Invention | E | Height of Ventilated Section (H), | 0.25 | 0.25 | 0.25 |
| B | | | meter | | | |
| | | F | Cross section area of Ventilated | 0.55 | 0.69 | 0.75 |
| | | | Section, square meter | | | |
| | | G | Total Cross section area for gas to | 0.91 | 1.46 | 3.18 |
| | | | escape (D + F), square meter | | | |
| | | H | % increase in cross section area | 152% | 88.4% | 30.7% |

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

1. A reduction vessel having a reduction zone comprising an upper zone and a lower zone wherein said upper zone comprises an annular shaped baffle and an annular shaped opening and wherein a portion of said annular shaped baffle adjacent to said opening is a ventilated section.

2. The vessel of claim 1 wherein said portion of said baffle comprises a screen or ventilation device.

3. The vessel of claim 2 wherein said screen is a profile wire screen.

4. The vessel of claim 1 wherein said ventilated section is annular in configuration and wherein said ventilated section is from 1 to 24 inches (25.4 to 611 mm) in height measured in a vertical direction along said reduction vessel.

5. The vessel of claim 1 wherein said lower zone comprises a lower annular baffle.

6. An apparatus to increase a flow of gas exiting a reaction vessel comprising a cylindrical shaped reactor wherein within said cylindrical shaped reactor is positioned at least one annular baffle wherein a portion of a surface of said annular baffle comprises a screen.

7. The apparatus of claim 6 wherein about 70 to 100 percent of said upper reduction gas flow exits the said ventilation device inside the reduction vessel.

8. The apparatus of claim 6 wherein said at least one annular baffle is an upper annular baffle.

9. The apparatus of claim 6 wherein said at least one annular baffle further comprises a lower annular baffle.

10. The apparatus of claim 6 wherein said screen has a length that is 10-40% of a length of said upper annular baffle.

11. The apparatus of claim 6 wherein below said screen is a catalyst free surface area.
